(19) United States
(12) Patent Application Publication
(10) Pub. No.: US 2022/0022375 A1
(43) Pub. Date: Jan. 27, 2022

(54) HARVESTER IMPLEMENT DEGREE OF CROP PROCESSING SENSOR SYSTEM

(71) Applicant: DEERE & COMPANY, Moline, IL (US)

(72) Inventors: COLE L. MURRAY, POLK CITY, IA (US); ZACHARY T. BONEFAS, GRIMES, IA (US); JEFFREY M. MANNING, Urbandale, IA (US)

(21) Appl. No.: 16/934,216

(22) Filed: Jul. 21, 2020

(51) Int. Cl. A01D 41/127; A01D 45/02; A01F 11/06; A01D 82/00; H04N 5/225; G06T 7/00

(52) U.S. Cl. CPC A01D 41/127; A01D 45/028; A01F 11/06; A01D 90/02; H04N 5/2253; H04N 5/2252; G06T 7/0004; A01D 82/00

(57) ABSTRACT

A harvester implement includes a crop processor positioned to receive the crop material from a head unit and process the crop material to alter a characteristic of the crop material, e.g., a cut length or a kernel processing score. An image sensor assembly is positioned downstream of the crop processor along a flow path of the crop material. The image sensor assembly is operable to capture a post-processing image of the crop material. A computing device is operable to execute a crop processing analysis algorithm to receive the post-processing image of the crop material from the image sensor assembly, and to analyze the post-processing image to determine an actual degree of processing to the characteristic of the crop material achieved by the crop processor. The computing device may then communicate a notification signal to an output indicating the actual degree of processing to the characteristic of the crop material.

### TECHNICAL FIELD

The disclosure generally relates to a harvester implement for harvesting and processing crop material for forage.

### BACKGROUND

A harvester implement gathers crop material from a field and directs the crop material through a pair of opposing feed rollers. The crop material is fed between the opposing feed rollers, which move the crop material along a processing flow path. The feed rollers counter-rotate relative to each other to move the crop material in a direction of crop processing, which is generally rearward relative to a direction of travel of the harvester implement. Crop processing operations may include one or more post collection operations that improves the digestibility of the crop material, thereby increasing nutrient value of the crop material when consumed by animals.

The crop processing operations may include, but are not limited to, cutting the crop material to a length and/or fracturing/cracking kernels of the crop material. For example, the crop material may move along the flow path through a cutter head. The cutter head includes a rotating drum with a plurality of knives disposed on the periphery of the drum. The cutter head cooperates with a shear bar to cut stem portions of the crop material into small pieces. Following the cutter head, the crop material may flow through a kernel processor. The kernel processor includes a pair of processing rolls spaced apart from each other by a roll gap. Kernels in the crop material are fractured, i.e., cracked, as they move between the pair of processing rolls. The crop material is directed from the kernel processor into a discharge spout, which directs the crop material through an exit and into a storage container.

A maximum potential nutrient value of the crop material may be achieved when the crop material is processed to a desired degree or level of processing. Failure to process the crop material to these desired levels may result in the crop material failing to deliver its maximum potential nutrient value to an animal when consumed. The nutrients of the crop material that are not absorbed by the animal are wasted, thereby reducing the effectiveness and/or efficiency of the crop material as animal feed. Accordingly, it is desirable to process the crop material to the desired degree or level of processing to maximize nutrient absorption by the animal.

### SUMMARY

A harvester implement is provided. The harvester implement may include a head unit that is operable to gather crop material and direct the crop material along a flow path. A crop processor is positioned to receive the crop material from the head unit. The crop processor at least partially defines the flow path of the crop material. The crop processor is operable to process the crop material to alter a characteristic of the crop material. An image sensor assembly is positioned downstream of the crop processor along the flow path of the crop material. The image sensor assembly is operable to capture a post-processing image of the crop material as the crop material moves along the flow path. A computing device is disposed in communication with the image sensor assembly. The computing device includes a processor and a memory having a crop processing analysis algorithm stored thereon. The processor is operable to execute the crop processing analysis algorithm to receive the post-processing image of the crop material from the image sensor assembly, and to analyze the post-processing image. The computing device analyzes the post-processing image of the crop material to determine an actual degree of processing to the characteristic of the crop material achieved by the crop processor. The computing device may then communicate a notification signal to an output indicating the actual degree of processing to the characteristic of the crop material.

In one aspect of the disclosure, the harvester implement includes a discharge spout that is positioned to receive the crop material from the crop processor. The discharge spout at least partially defines the flow path of the crop material. The discharge spout includes an exit, which may be positioned to direct the flow of crop material into a storage container, such as but not limited to, an onboard container, or an adjacent truck or trailer.

In one implementation of the disclosure, the image sensor assembly is positioned in the discharge spout to capture the post-processing image of the crop material while moving through the discharge spout. However, it should be appreciated that the image sensor assembly may be positioned at other locations relative to the harvester implement. Additionally, it should be appreciated that the image sensor assembly may be positioned on the harvester implement, on the storage container, or on some other vehicle. For example, in one implementation, the image sensor assembly may be positioned to capture the post-processing image of the crop material in the storage container. In yet another implementation, the image sensor assembly may be positioned to capture the post-processing image upstream of the discharge spout relative to the flow path of the crop material.

In one aspect of the disclosure, the characteristic of the crop material may include a cut length. The crop processor includes a cutter head that is operable to cut the crop material to alter the cut length of the crop material. The processor of the computing device is operable to execute the crop processing analysis algorithm to analyze the post-processing image to determine an actual cut length of the crop material achieved by the cutter head.

In one aspect of the disclosure, the characteristic of the crop material may include a kernel wall. As used herein, the term “kernel wall” includes the bran layer of a grain. As understood by those skilled in the art, the bran layer is the hard outer layer of a grain that protects the seed. The crop processor includes a kernel processor that is operable to crack or fracture the kernel wall. The processor of the computing device is operable to execute the crop processing analysis algorithm to analyze the post-processing image to determine an actual degree or level of kernel fracture or cracking. Additionally, the processor of the computing device may be operable to execute the crop processing analysis algorithm to relate the actual degree of kernel fracture to a kernel processing score.

In one implementation of the disclosure, the image sensor assembly includes a window covering that is exposed to the crop material moving along the flow path. The window covering may include and/or be manufactured from a sapphire glass, a ceramic glass, or some other transparent material having a substantially similar hardness and/or abrasion resistance.

In one implementation of the disclosure, the image sensor assembly may include a housing defining an interior region. The housing includes and/or supports at least one light source within the interior region. In one implementation, the housing includes two light sources within the interior region. In one aspect of the disclosure, the light source may be positioned to provide direct lighting through the window covering and onto the crop material in the flow path. In one aspect of the disclosure, the light source may include a pulsed Light Emitting Diode (LED).

In one aspect of the disclosure, the image sensor assembly includes a camera module. The camera module is operable to capture the post-processing image in a visible light spectrum. The visible light spectrum may include light having a wavelength between the range of approximately 300 nanometers and 800 nanometers. The cameral module may include or exhibit a shutter speed approximately equal to or less than twenty milliseconds.

In one aspect of the disclosure, a Near InfraRed (NIR) sensor may be positioned to capture a NIR image of the crop material in a NIR light spectrum. The NIR light spectrum may include light having a wavelength between the range of approximately 700 nanometers and 2,500 nanometers. The processor may be operable to execute the crop processing analysis algorithm to analyze the NIR image to determine a starch content. The processor may further be operable to execute the crop processing analysis algorithm to communicate the notification signal to the output, such that the notification signal indicates the starch content.

In one aspect of the disclosure, the output may include a visual display capable of generating and displaying a visual image. However, it should be appreciated that the output may include, but is not limited to, some other device capable of communicating a message, such as an audio output or a signal transmitter. The visual display may include, but is not limited to, a touchscreen display enabling user input. In one implementation of the disclosure, the processor may be operable to execute the crop processing analysis algorithm to communicate the notification signal to present the post-processing image on the visual display.

In another implementation of the disclosure, the processor may be operable to execute the crop processing analysis algorithm to communicate the notification signal to the output, such that the notification signal indicates an actual cut length of the crop material. In another implementation of the disclosure, the processor may be operable to execute the crop processing analysis algorithm to communicate the notification signal to the output, such that the notification signal indicates an actual degree of kernel processing and/or a kernel processing score.

In one aspect of the disclosure, the processor may be operable to execute the crop processing analysis algorithm to compare the actual degree of processing to a pre-defined allowable characteristic range. The computer device may make the comparison to determine if the actual degree of processing is equal to or within the pre-defined allowable characteristic range, or if the actual degree of processing is outside the allowable characteristic range. In one implementation of the disclosure, the notification signal may indicate that the actual degree of processing is equal to or within the pre-defined allowable characteristic range, or that the actual degree of processing is outside the allowable characteristic range.

In one aspect of the disclosure, the processor may be operable to execute the crop processing analysis algorithm to identify a potential maintenance requirement associated with the crop processor based on the actual degree of processing to the crop material achieved by the crop processor.

In another aspect of the disclosure, the processor may be operable to execute the crop processing analysis algorithm to automatically adjust the crop processor to change the actual degree of processing to the crop material achieved by the crop processor. For example, the computing device may alter the position and/or configuration of the cutter head and/or the kernel processor to change the actual cut length or the actual degree of kernel fracture. In another implementation, the processor may be operable to recommend and/or communicate proposed manual adjustments to the crop processor to an operator so that the operator may decide whether or not to implement the proposed adjustments to the crop processor.

In one aspect of the disclosure, the processor may be operable to execute the crop processing analysis algorithm to determine a geographic location of the crop material captured in the post-processing image. The computing device may then associate the geographic location with the post-processing image.

In one aspect of the disclosure, the processor may be operable to execute the crop processing analysis algorithm to communicate the post-processing image, the actual degree of processing to the crop material, and the geographic location associated with the post-processing image, to a remote data storage location. Additionally, the computing device may be configured to receive a setting control input signal from a remote transmitter. The processor may be operable to execute the crop processing analysis algorithm to adjust the crop processor to change the actual degree of processing of the crop material based on the setting control signal received from the remote location.

Accordingly, the harvester implement described herein enables on-machine monitoring of the degree or level of alteration to crop material achieved by the crop processor. Because the degree of alteration to the crop material is monitored on the machine, at the time of collection and processing, an operator, either located directly on the machine or remote from the machine, may make real-time changes to the crop processor to achieve a desired level of crop processing to maximize the nutrient absorption potential of the crop material.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic cut-away side view of a harvester implement.

FIG. 2 is a schematic plan view of the harvester implement.

FIG. 3 is a schematic plan view of a visual display of the harvester implement.

FIG. 4 is a schematic cross-sectional view of an image sensor assembly.

FIG. 5 is a schematic diagram of the harvester implement.

FIG. 6 is a flowchart showing a process of operating the harvester implement.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

Referring to the Figures, wherein like numerals indicate like parts throughout the several views, a harvester implement is generally shown at 20. The harvester implement 20 shown in the Figures and described herein is configured as a forage harvester. However, it should be appreciated that the harvester implement 20 may be configured differently than the example forage harvester shown in the Figures and described herein.

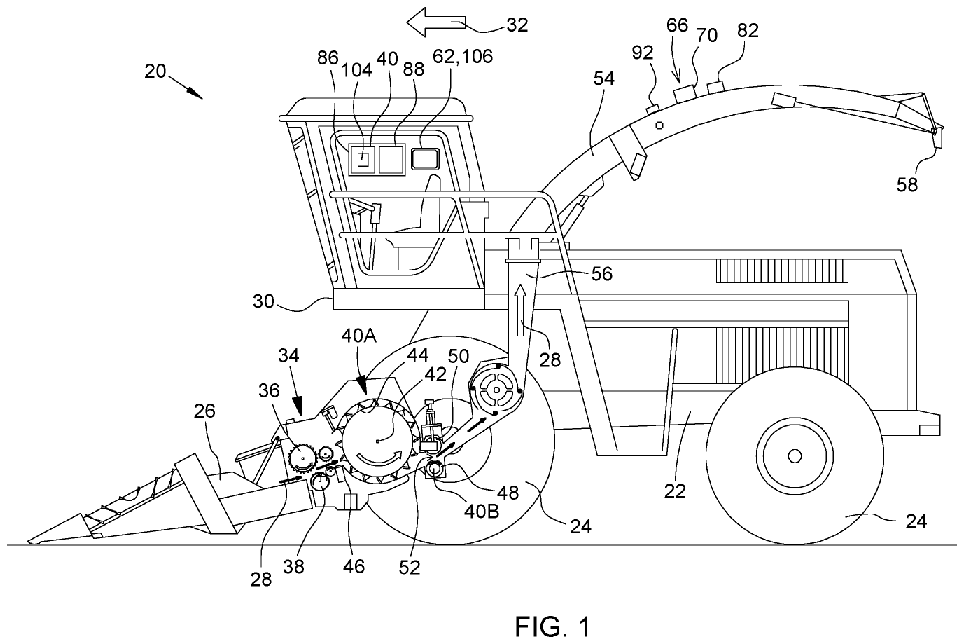

Referring to FIG. 1, the harvester implement 20 includes a frame 22, which supports the various components of the harvester implement 20. The frame 22 rotatably supports a plurality of ground engaging elements 24, such as but not limited to a pair of front wheels or tracks and a pair of rear wheels or tracks. In the example embodiment shown in FIG. 1 and described herein, the front wheels are drive wheels and the rear wheels are steerable wheels. However, it should be appreciated that the ground engaging elements 24 and the propulsion and steering thereof, may differ from the example embodiment shown in FIG. 1 and described herein.

Referring to FIG. 1, the harvester implement 20 includes a head unit 26. The head unit 26 is operable to gather crop material from a field and direct the crop material through the harvester implement 20 along a flow path 28. The head unit 26 is disposed at the forward end 30 of the harvester implement 20, relative to a direction of travel 32 of the harvester implement 20 when gathering the crop material. The head unit 26 is attached to and supported by the frame 22. The configuration and operation of the head unit 26 may vary depending upon the crop material being gathered. FIG. 1 shows an implementation of the head unit 26 operable for cutting and gathering standing corn. It should be appreciated that the head unit 26 may differ for other crop materials, such as alfalfa, grasses, sorghum, cereals, barley, fine grains, course grains, or other crop materials. The different configurations and operation of the different head units 26 are known to those skilled in the art, are not pertinent to the teachings of this disclosure, and are therefore not described in detail herein.

Referring to FIG. 1, the harvester implement 20 includes a feeder 34. The feeder 34 is positioned immediately rearward of the head unit 26 relative to the flow path 28 of the crop material. The feeder 34 is operable to move crop material gathered by the head unit 26 in a direction of crop processing and along the flow path 28. The direction of crop processing is generally directed rearward and possibly laterally relative to the direction of travel 32 of the harvester implement 20 when gathering crop material. In the example embodiment described herein, the feeder 34 may include a pair of opposing feed rollers, i.e., an upper feed roller 36 and a lower feed roller 38. The upper feed roller 36 and the lower feed roller 38 are spaced apart from each, with the gathered crop material fed between the upper feed roller 36 and the lower feed roller 38. The upper feed roller 36 and the lower feed roller 38 are counter-rotated relative to each other to move the crop material therebetween. The specific details and operation of the feeder 34 are known to those skilled in the art, are not pertinent to the teachings of this disclosure, and are therefore not described in greater detail herein. Furthermore, the configuration and operation of the feeder 34 may differ from the example embodiment shown in the Figures and described herein.

Referring to FIG. 1, the harvester implement 20 further includes at least one crop processor 40A, 40B. The crop processor 40A, 40B is disposed downstream of the feeder 34 relative to the direction of crop processing of the crop material. The crop processor 40A, 40B may include, but is not limited to, a cutter head 40A and/or a kernel processor 40B. The crop processor 40A, 40B is positioned to receive the crop material from the head unit 26 and partially define the flow path 28 of the crop material. In the example implementation described herein, the crop processor 40A, 40B receives the crop material from the head unit 26 via the feeder 34. The crop processor 40A, 40B is operable to process the crop material to alter a characteristic of the crop material. The characteristic of the crop material may include a physical, chemical, or nutritional property of one or more components of the crop material. For example, the characteristic of the crop material may include, but is not limited to, a length of stem portions of the crop material, a degree of fracture or cracking of the stem portions of the crop material, or a degree of fracture or cracking of kernel portions or a kernel wall of the crop material.

In the example implementation shown in the Figures, the cutter head 40A is positioned downstream of the feeder 34, relative to the flow path 28 of the crop material. The cutter head 40A is rotatably attached to the frame 22 and is rotatable about an axis of rotation. The axis of rotation of the cutter head 40A is generally perpendicular to the direction of travel 32 of the harvester implement 20 while gathering crop material, and generally perpendicular to the direction of crop processing. The example embodiment of the cutter head 40A shown in the Figures and described herein includes a cylindrical drum 42 having a plurality of knives 44 disposed circumferentially about the outer periphery of the drum 42.

Referring to FIG. 1, a shear bar 46 is located immediately downstream of the feeder 34 relative to the direction of crop processing of the crop material. The shear bar 46 is attached to and supported by the frame 22. The cutter head 40A cooperates with the shear bar 46 to cut the crop material into smaller pieces, with each of the smaller pieces having or defining a respective cut length. As such, the characteristic of the crop material may include the cut length of the stem portions of the crop material, with the at least the feeder 34 and/or the cutter head 40A being operable to alter the cut length of the stem portions of the crop material. The drum 42 of the cutter head 40A rotates in a rotational direction about its axis of rotation, with the knives 44 oriented to cut the crop material when the drum 42 rotates. The shear bar 46 braces the crop material against the cutting action of the knives 44 to facilitate the cutting of the crop material. At least one of the shear bar 46 and the cylindrical drum 42 may move relative to the frame 22 such that the shear bar 46 and the cylindrical drum 42 may be moveable relative to each other to adjust the cut length of the crop material. The specific features and operation of the cutter head 40A and its relation to the shear bar 46 with regard to cutting the crop material to the cut length are known to those skilled in the art, are not pertinent to the teachings of this disclosure, and are therefore not described in greater detail herein.

Referring to FIG. 1, the kernel processor 40B is positioned downstream of the cutter head 40A relative to the flow path 28 of the crop material, and receives the crop material from the cutter head 40A. The kernel processor 40B includes a pair of opposing processing rolls, i.e., a first processing roll 48 and a second processing roll 50. The first processing roll 48 and the second processing roll 50 are rotated at different speeds to further process portions of the crop material, e.g., kernels of the crop material, by fracturing or cracking one or more walls of the kernels. As such, the characteristic of the crop material may include the wall of the kernels, i.e., the kernel wall, with the kernel processor 40B being operable to crack or fracture the kernel wall of the kernels of the crop material. As used herein, the term “kernel wall” includes the bran layer of a grain. As understood by those skilled in the art, the bran layer is the hard outer layer of a grain that protects the seed. The first processing roll 48 and the second processing roll 50 are separated by a roll gap 52 and are biased together. The roll gap 52 may be between, approximately, 0.75 mm and 3.0 mm. For example, one implementation includes the roll gap 52 set between approximately 1.5 mm and 2.0 mm. At least one of the first processing roll 48 and the second processing roll 50 is moveable relative to the frame 22, such that the first processing roll 48 and the second processing roll 50 are moveable relative to each other to adjust the distance of the roll gap 52 for different crop materials. Each of the first processing roll 48 and the second processing roll 50 may include teeth, ridges, valleys, etc., that help fracture and/or crack the kernel walls of the kernel portions of the crop material to improve digestibility. The specific features and operation of the kernel processor 40B and relative positioning between the first processing roll 48 and the second processing roll 50 to adjust the roll gap 52 and control the amount of kernel fracture in the crop material are known to those skilled in the art, are not pertinent to the teachings of this disclosure, and are therefore not described in greater detail herein.

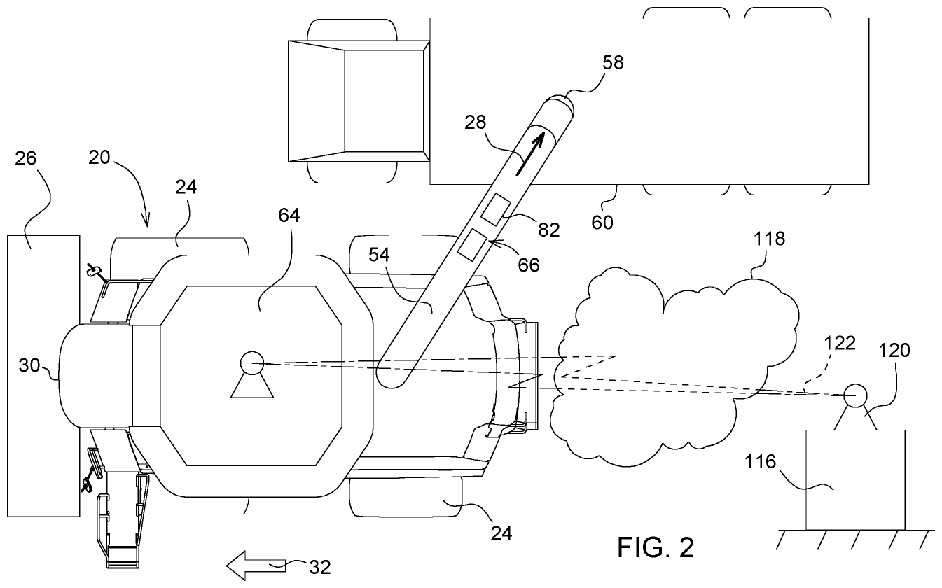

The harvester implement 20 further includes a discharge spout 54. The discharge spout 54 is positioned downstream of the kernel processor 40B relative to the flow path 28 of the crop material. The discharge spout 54 includes an inlet 56 positioned to receive the crop material from the crop processor 40A, 40B, e.g., the cutter head 40A and the kernel processor 40B, and partially defines the flow path 28 of the crop material. The discharge spout 54 may include an exit 58 that is positioned to expel the crop material into a storage container 60. The discharge spout 54 may include, but is not limited to, an elongated tubular structure that is shaped to guide and direct the crop material into the storage container 60. In one implementation, the storage container 60 may include a bin supported by the frame 22 and integral with the harvester implement 20. In another implementation, such as shown in FIG. 2, the storage container 60 may include a truck, trailer, dump truck, semi-truck and trailer, or other similar vehicle and/or vehicle trailer combination that is positioned adjacent to the harvest implement and positioned to receive the crop material from the discharge spout 54.

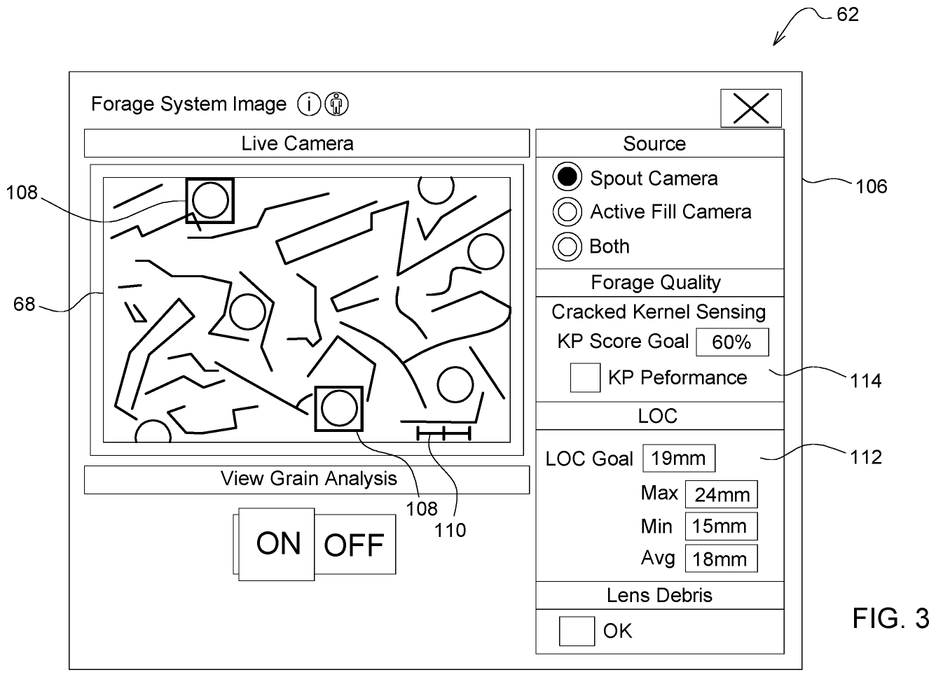

Referring to FIG. 1, the harvester implement 20 may further include an output 62. The output 62 may include a device that is capable of delivering a message to a user. For example, in one implementation, the output 62 includes a visual display 106, such as but not limited to a visual monitor or touch screen display that is capable of displaying images and receiving an input from a user, such as shown in FIG. 3. The output 62 may be located in a cab 64 of the harvester implement 20 and positioned in view of the user. The output 62 may further, or alternatively, include an audio device such as a speaker, an indicator lamp, or some other device capable of delivering a message to a user.

Referring to FIG. 1, an image sensor assembly 66 is positioned downstream of the crop processor 40A, 40B along the flow path 28 of the crop material. The image sensor assembly 66 is operable to capture a post-processing image 68 of the crop material as the crop material moves along the flow path 28. As used herein, the term “post-processing image 68” includes an image taken of the crop material moving along the flow path 28 of the crop material after the crop material has been processed by at least one crop processor 40A, 40B. In the example implementation described herein and shown in the figures, the image sensor assembly 66 is positioned in the discharge spout 54, downstream of both the cutter head 40A and the kernel processor 40B. In this position, the image sensor assembly 66 may capture an image of the crop material after processing by both the cutter head 40A and the kernel processor 40B. However, the image sensor assembly 66 may be positioned elsewhere on the harvester implement 20 relative to the flow path 28 of the crop material. For example, the image sensor assembly 66 may be positioned to capture the post-processing image 68 upstream of the discharge spout 54 relative to the flow path 28 of the crop material. In one implementation, the image sensor assembly 66 may be positioned downstream of the cutter head 40A, but upstream of the kernel processor 40B. In this alternative position, the image processing assembly may capture an image of the crop material after processing by the cutter head 40A, but before processing by the kernel processor 40B.

In other alternative implementations, the image sensor assembly 66 may be positioned to capture the post-processing image 68 of the crop material as the crop material is expelled from the discharge spout 54 and/or deposited in the storage container 60. As such, the image sensor assembly 66 may be located on an exterior of the harvester implement 20 and positioned to capture the flow of the crop material as the crop material is dispensed from the exit 58 of the discharge spout 54 and into the storage container 60. In yet another implementation, the image sensor assembly 66 may be located on the storage container 60, e.g., a truck or trailer positioned adjacent to the forage harvester. In this implementation, the image sensor assembly 66 may be positioned to capture the flow of the crop material as the crop material is dispensed from the exit 58 of the discharge spout 54 and into the storage container 60. It should be appreciated that the image sensor assembly 66 may be positioned at some other location not specifically described herein, either on or off the harvester implement 20, that enables the image sensor assembly 66 to capture the post-processing image 68 of the crop material.

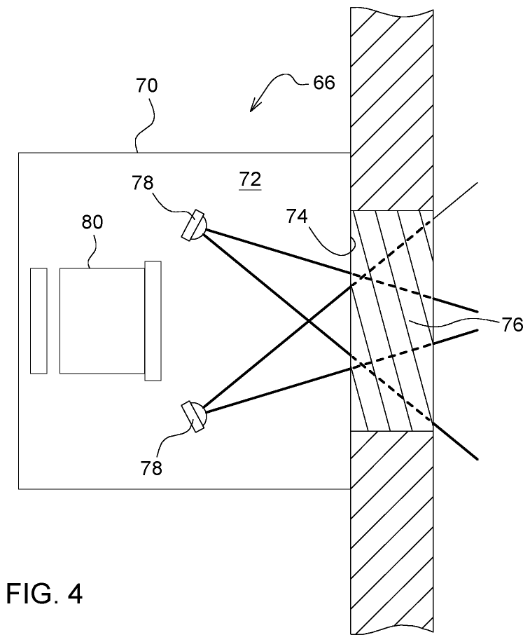

Referring to FIG. 4, the image sensor assembly 66 may include a housing 70 defining an interior region 72. The housing 70 includes an opening 74 or an aperture, through which light may enter and exit 58 the interior region 72 of the housing 70. The image sensor assembly 66 may include a window covering 76 that is positioned to extend over and cover the opening 74 in the housing 70. In the example implementation shown in the Figures and described herein, the window covering 76 is positioned within and at least partially forms a wall 84 of the discharge spout 54. As such, the window covering 76 is exposed to the crop material moving along the flow path 28 and through the discharge spout 54.

Because the crop material may include abrasive materials, the window covering 76 may include and/or be manufactured from an abrasive resistant material. For example, the window covering 76 may include or be manufactured from a sapphire glass or ceramic glass. However, it should be appreciated that the window covering 76 may include and be manufactured from some other transparent, abrasion resistant material, not mentioned or described herein.

Referring to FIG. 4, the housing 70 of the image sensor assembly 66 supports at least one light source 78 within the interior region 72 of the housing 70. As shown in the example implementation, the image sensor assembly 66 includes two light sources 78. However, it should be appreciated that the number of light sources 78 within the interior region 72 may vary from the example implementation. For example, the number of light sources 78 may alternatively include one light source 78, or three or more light sources 78.

Each of the light sources 78 positioned within the interior region 72 of the housing 70 is positioned to provide direct lighting through the opening 74 of the housing 70 and through the window covering 76 extending over the opening 74, and onto the crop material in the flow path 28. As used herein, the term “direct lighting” is defined as illumination directly from the light source 78 that has not been reflected off of another surface.

In the example implementation described herein, each of the light sources 78 may include a pulsed light source 78. As used herein, the term “pulsed” defines a light source 78 that is controlled on/off for each post-processing image 68 that is captured. In other words, the pulsed light source 78 is not continuously on, but is rather turned on in order to capture the post-processing image 68, then turned off. In the example implementation described herein, each of the light sources 78 may include, but are not limited to, a Light Emitting Diode (LED) that is operable to emit light in the visible light spectrum. The visible light spectrum may include light having a wavelength between the range of approximately 380 nanometers and 700 nanometers. While the example implementation of the light sources 78 includes LED lights, it should be appreciated that the light sources 78 may include some other construction not described herein that is capable of emitting light in the visible light spectrum.

Referring to FIG. 4, the image sensor assembly 66 includes a camera module 80. The camera module 80 is operable to capture the post-processing image 68 of the crop material. In the example implementation described herein, the camera module 80 includes an exposure or shutter speed that is equal to or less than twenty milliseconds. The shutter speed allows the cameral module to capture the post-processing image 68 of the crop material with sufficient clarity for object recognition analysis as the crop material moves through the discharge spout 54.

In the example implementation described herein, the camera module 80 is operable to capture the post-processing image 68 in the visible light spectrum. As noted above, the visible light spectrum includes light having a wavelength between the range of approximately 380 nanometers and 700 nanometers. While the example implementation of the light sources 78 and the camera module 80 include emitting light and capturing images in the visible light spectrum, it should be appreciated that other light spectrums may alternatively be used.

Referring to FIG. 1, in addition to the image sensor assembly 66, the harvester implement 20 may further include a Near InfraRed (NIR) sensor. The NIR sensor 82 is positioned to capture a NIR image of the crop material in a NIR light spectrum. The NIR sensor 82 may be positioned at any point along the flow path 28 of the crop material. In the example implementation shown in the Figures and described herein, the NIR sensor 82 is positioned within the wall 84 of the discharge spout 54 to capture the NIR image of the crop material within the discharge spout 54. The NIR sensor 82 captures the NIR image in the NIR light spectrum. The NIR light spectrum includes light having a wavelength between the range of approximately 700 nanometers and 2,500 nanometers.

Referring to FIG. 1, the harvester implement 20 may further include a computing device 86. The computing device 86 is disposed in communication with the image sensor assembly 66 and the NIR sensor 82. The computing device 86 may alternatively be referred to as a computer, a controller, a control unit, a control module, etc. The computing device 86 may be located on the harvester implement 20, or remote from the harvester implement 20. The computing device 86 is operable to monitor the operation of the crop processor 40A, 40B, and may additionally be operable to control the operation of the harvester implement 20. The computing device 86 includes a processor 88, a memory 90, and all software, hardware, algorithms, connections, sensors 92, etc., necessary to monitor and/or control the operation of the one or more components of the harvester implement 20, such as but not limited to, the crop processor 40A, 40B, the feeder 34, the cutter head 40A, etc. As such, a method may be embodied as a program or algorithm operable on the computing device 86. It should be appreciated that the computing device 86 may include any device capable of analyzing data from various sensors 92, comparing data, making the necessary decisions required to monitor and/or control the operation of the crop processor 40A, 40B, the feeder 34, the cutter head 40A, or some other component of the harvester implement 20.

As used herein, “computing device” or “controller” are intended to be used consistent with how the term is used by a person of skill in the art, and refers to a computing component with processing, memory 90, and communication capabilities, which is utilized to execute instructions (i.e., stored on the memory 90 or received via the communication capabilities) to control or communicate with one or more other components. In certain embodiments, a controller may also be referred to as a control unit, vehicle control unit (VCU), engine control unit (ECU), transmission control unit (TCU), or electrical controller. In certain embodiments, a controller may be configured to receive input signals in various formats (e.g., hydraulic signals, voltage signals, current signals, CAN messages, optical signals, radio signals), and to output 62 command or communication signals in various formats (e.g., hydraulic signals, voltage signals, current signals, CAN messages, optical signals, radio signals).

The computing device 86 may be in communication with other components on the harvester implement 20, such as hydraulic components (e.g., valve block), electrical components (e.g., solenoid, accumulator sensor), actuators, sensors 92, and operator inputs within an operator station of the work vehicle. The computing device 86 may be electrically connected to these other components by a wiring harness such that messages, commands, and electrical power may be transmitted between the computing device 86 and the other components. Although the computing device 86 is referenced in the singular, in alternative implementations the configuration and functionality described herein can be split across multiple computing device 86s using techniques known to a person of ordinary skill in the art.

The computing device 86 may be embodied as one or multiple digital computers or host machines each having one or more processors 88, read only memory (ROM), random access memory (RAM), electrically-programmable read only memory (EPROM), optical drives, magnetic drives, etc., a high-speed clock, analog-to-digital (ND) circuitry, digital-to-analog (D/A) circuitry, and any required input/output (I/O) circuitry, I/O devices, and communication interfaces, as well as signal conditioning and buffer electronics.

The computer-readable memory 90 may include any non-transitory/tangible medium which participates in providing data or computer-readable instructions. The memory 90 may be non-volatile or volatile. Non-volatile media may include, for example, optical or magnetic disks and other persistent memory. Example volatile media may include dynamic random access memory (DRAM), which may constitute a main memory. Other examples of embodiments for memory include a floppy, flexible disk, or hard disk, magnetic tape or other magnetic medium, a CD-ROM, DVD, and/or any other optical medium, as well as other possible memory devices such as flash memory.

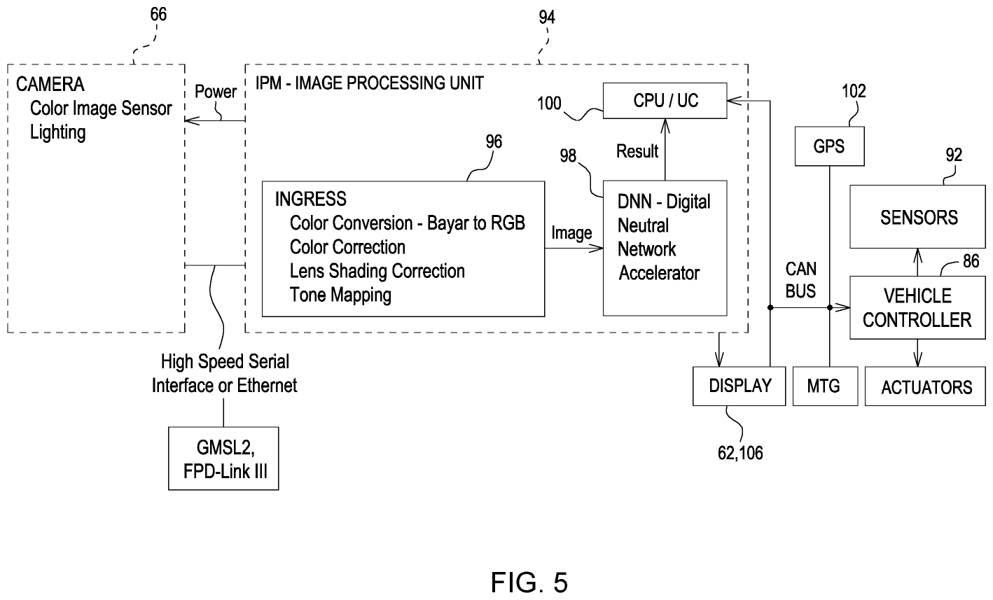

Referring to FIG. 5, the computing device 86 may include an image processing unit 94 that receives, manipulates, and analyzes the post-processing image 68 from the image sensor assembly 66. The image processing unit 94 may include, but is not limited to, an ingress 96 that is capable of performing color conversion and/or correction on the post-processing image 68, lens shading correction on the post-processing image 68, and/or tone mapping of the post processing image. In addition to the ingress 96, the image processing unit 94 may include a digital neural network accelerator 98 and a dedicated processing unit or microprocessor 100. The computing device 86 may further include a Global Position Satellite (GPS) system 102 that is operable to receive location signals and calculate or determine a location based on the received location signals.

As described above, the computing device 86 includes the processor 88 and the memory 90. The memory 90 includes a crop processing analysis algorithm 104 stored thereon. The processor 88 is operable to execute the crop processing analysis algorithm 104 to implement a method of monitoring the operation of the crop processor 40A, 40B, and/or controlling the harvester implement 20.

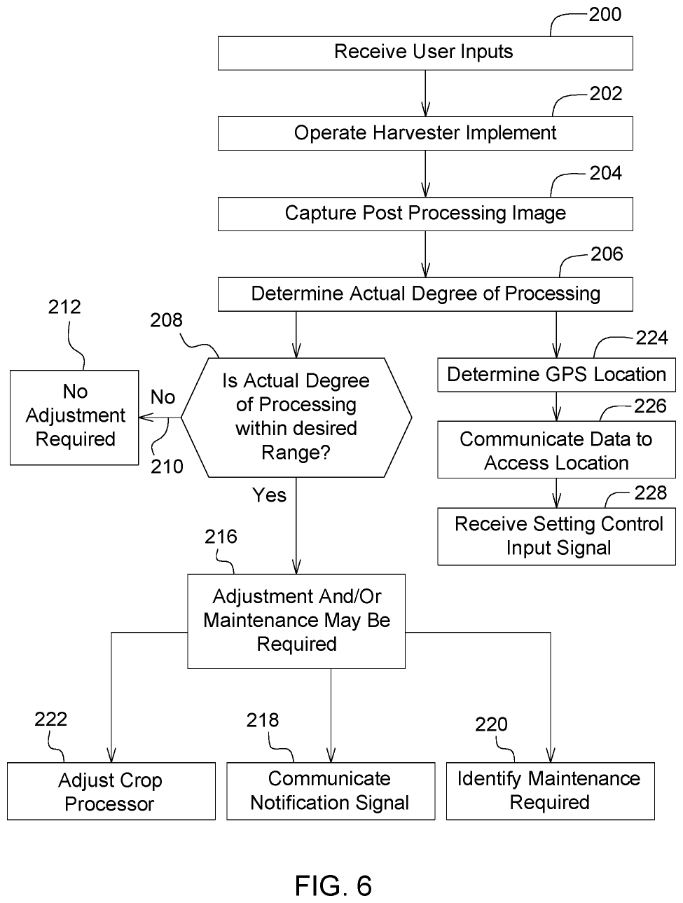

Referring to FIG. 6, the processor 88 is operable to execute the crop processing analysis algorithm 104 to receive a user input providing a pre-defined allowable characteristic range of crop conditioning. The step of receiving the user input is generally indicated by box 200 in FIG. 6. The specific type and/or value of the user input is dependent upon the specific characteristic of the crop material being altered by the crop processor 40A, 40B. For example, if the crop processor 40A, 40B is configured as the cutter head 40A, then the user input may include a desired length of cut. Alternatively, if the crop processor 40A, 40B is configured as the kernel processor 40B, then the user input may include a desired cracked kernel score. The pre-defined allowable characteristic range for crop conditioning may be input into the computing device 86 using a suitable input device, such as but not limited to, a keyboard, a touch screen display, audio receiver, joystick, etc. The input device may be separate from, or integral with the output 62.

Once the desired level of crop conditioning has been input into the computing device 86, operation of the harvester implement 20 may begin. The step of operating the harvester implement 20 is generally indicated by box 202 in FIG. 6. It should be appreciated that operation of the harvester implement 20 includes maneuvering the harvester implement 20 through a field, whereby the head unit 26 gathers the crop material from the field. Once the crop material is gathered, the feeder 34 moves the crop material in the direction of crop processing along the flow path 28 of the crop material. In the example implementation of the harvester implement 20 shown in the figures and described herein, the crop material moves through the cutter head 40A, whereby the stem portions of the crop material are cut to define an actual cut length of the stem portions. Following the cutter head 40A, the crop material moves through the kernel processor 40B, whereby the walls of the kernel portions of the crop material are fractured or cracked. Upon exiting the kernel processor 40B, the crop material moves through the entrance of the discharge spout 54. The discharge spout 54 directs the crop material therethrough, and dispenses the crop material through the exit 58 of the discharge spout 54, into the storage container 60.

In the example implementation of the harvester implement 20 described herein, as the crop material moves through the discharge spout 54, the processor 88 is operable to execute the crop processing analysis algorithm 104 to activate the light source 78 of the image sensor assembly 66 to illuminate the crop material adjacent to the window covering 76 and then actuate the camera module 80 to capture the post-processing image 68 of the crop material. The step of capturing the post-processing image 68 is generally indicated by box 204 in FIG. 6.

The processor 88 is operable to execute the crop processing analysis algorithm 104 to receive the post-processing image 68 of the crop material from the image sensor assembly 66. The post-processing image 68 may then be stored in the memory 90 of the computing device 86. The post-processing image 68 may be communicated between the image sensor assembly 66 and the computing device 86 through a wired connection, a wireless connection, a CAN bus, etc.

The computing device 86 may then analyze the post-processing image 68 to determine an actual degree of processing to the characteristic of the crop material achieved by the crop processor 40A, 40B. The step of determining the actual degree of processing to the characteristic of the crop material is generally indicated by box 206 in FIG. 6. In order to determine the actual degree of processing, the computing device 86 may use object recognition software to identify specific components or portions of the crop material, e.g., stem portions or kernel portions, and then use artificial intelligence, a neural network, or some other application to ascertain the actual degree of processing of the crop material achieved by the crop processor 40A, 40B. For example, the computing device 86 may use object recognition software to identify a stem portion of the crop material, and then use object measurement software to determine the actual cut length of the identified stem portion achieved by the cutter head 40A. In one implementation, the actual cut length of the identified stem portion may be expressed as an actual length measurement, e.g., twenty two millimeters (22 mm). In other implementations, the actual cut length may be expressed in some other manner, such as being rated on a defined scale 110 representing short, medium, and long lengths.

In another example, the computing device 86 may use object recognition software to identify a kernel portion of the crop material, and then use artificial intelligence software to compare the identified kernel portion to pre-learned images stored in the memory 90 and related to specific degrees of kernel wall fracture. By doing so, the computing device 86 may determine how much of the wall of the kernel portion is fractured or cracked, i.e., an actual degree of kernel fracture. The computing device 86 may then relate the actual degree of kernel fracture to a kernel processing score. It should be appreciated that the kernel processing score may represent an industry accepted standard representing the amount, level, or percentage of the wall of the kernel that is cracked or fractured. For example, the United States Department of Agriculture (USDA) uses a Kernel Processing Score (KPS) providing a Goal level that is equal to or greater than seventy percent (70%) kernel wall fracture, and Adequate level that is between fifty percent (50%) and seventy percent (70%) kernel wall fracture, and a Poor level that is equal to or less than fifty percent (50%) kernel wall fracture. It should be appreciated that the USDA KPS score described above is merely exemplary, and that the desired level of crop conditioning and the actual degree of kernel fracture may be expressed in some other manner, using some other scale 110 or scoring system.

Once the actual degree of processing of the crop material has been determined, the processor 88 is operable to execute the crop processing analysis algorithm 104 to compare the actual degree of processing to the pre-defined allowable characteristic range to determine if the actual degree of processing is equal to or within the pre-defined allowable characteristic range or if the actual degree of processing is outside the allowable characteristic range. The step of determining if the actual degree of processing is within an allowable range is generally indicated by box 208 in FIG. 6. If the computing device 86 determines that the actual degree of processing is equal to or within the pre-defined allowable characteristic range, generally indicated at 210, then no adjustment to the crop processor 40A, 40B may be required, generally indicated by box 212 in FIG. 6. However, if the computing device 86 determines that the actual degree of processing is not equal to or within the pre-defined allowable characteristic range, i.e., that the actual degree of processing is outside the pre-defined allowable characteristic range, generally indicated at 214, then maintenance to the crop processor 40A, 40B and/or an adjustment to the crop processor 40A, 40B may be required in order to achieve the desired level of processing, which is generally indicated by box 216 in FIG. 6.

For example, the desired level of processing may include a desired cut length between the range of fifteen millimeters (15 mm) and twenty five millimeters (25 mm). If the actual cut length of the identified stem portion is determined to approximately seventy five millimeters (75 mm), then the computing device 86 may determine that the actual degree of processing, e.g., the actual cut length, is greater than the desired level of processing, i.e., the desired cut length, and thereby determine that maintenance and/or re-adjustment of one of the components of the harvester implement 20 may be required.

The computing device 86 may then communicate a notification signal to the output 62. The step of communicating the notification signal to the output 62 is generally indicated by box 218 in FIG. 6. The notification signal indicates the actual degree of processing to the characteristic of the crop material to the user. As described above, the output 62 may include the visual display 106. The notification signal may include the post-processing image 68, such that the post-processing image 68 is presented or displayed on the visual display 106. Additional indicia may be included in the post-processing image 68. For example, a bounding box 108 may be included in the post-processing image 68 to identify one or more portions of the crop material, e.g., a stem portion or a kernel portion, that were identified and analyzed by the computing device 86. Alternatively, the portions of the crop material that were identified and analyzed may be highlighted or colored for quick identification by the user. The portions of the crop material that were identified and analyzed may be colored using semantic segmentation or some other similar technique. Additionally, a scale 110 relating portions of the image to an actual size or length may be shown in the post-processing image 68. It should be appreciated that other indicia and/or information may additionally be included in the post-processing image 68 shown on the visual display 106.

The notification signal may include other data in addition to or as an alternative to the post-processing image 68. For example, the notification signal may indicate that the actual degree of processing is equal to or within the pre-defined allowable characteristic range or that the actual degree of processing is outside the allowable characteristic range. The notification signal may further include the actual cut length of the crop material in a first display section 112 of the output 62, and/or the actual degree of kernel processing or the kernel processing score in a second display section 114 of the output 62. It should be appreciated that other data may be included in the notification signal and presented on the visual display 106 as well, such as but not limited to, a geographic location of where the post-processing image 68 was taken, a time and date of the post-processing image 68, weather conditions at the time the post-processing image 68 was taken, etc.

As described above, if the computing device 86 determines that the actual degree of processing is not equal to or within the pre-defined allowable characteristic range, i.e., that the actual degree of processing is outside the pre-defined allowable characteristic range, generally indicated at 214, then maintenance to the crop processor 40A, 40B and/or an adjustment to the crop processor 40A, 40B may be required in order to achieve the desired level of processing. For this reason, the processor 88 may be operable to execute the crop processing analysis algorithm 104 to identify a potential maintenance requirement associated with the crop processor 40A, 40B based on the actual degree of processing to the crop material achieved by the crop processor 40A, 40B. The step of identifying a maintenance requirement is generally indicated by box 220 in FIG. 6. For example, the computing device 86 may receive data from position sensors that detect a position of the crop processor 40A, 40B, and based on the sensed position, may determine a theoretical degree of processing that should be achieved by the crop processor 40A, 40B. If the actual degree of processing that should be achieved is not approximately equal to the actual degree of processing, then the computing device 86 may determine that maintenance to the crop processor 40A, 40B is required.

The computing device 86 may be configured to detect or otherwise determine, based on the determination that the actual degree of processing is not equal to or within the pre-defined allowable characteristic range and other sensor data related to the crop processor 40A, 40B, that the knives 44 of the cutter head 40A require sharpening and/or replacement, that the first processing roll 48 and/or the second processing roll 50 are worn and are in need of replacement, that one or more bearings on the rotating cylindrical drum 42 of the cutter head 40A, the first processing roll 48 of the kernel processor 40B, or the second processing roll 50 of the kernel processor 40B are worn and need replacing, etc. It should be appreciated that other components and features of the crop processor 40A, 40B, not specifically identified and/or described herein, may be identified by the computing device 86 for maintenance based on the data obtained at least partially from the post-processing image 68.

Furthermore, if the computing device 86 determines that the actual degree of processing is not equal to or within the pre-defined allowable characteristic range, i.e., that the actual degree of processing is outside the pre-defined allowable characteristic range, then the processor 88 may be operable to execute the crop processing analysis algorithm 104 to automatically adjust the crop processor 40A, 40B to change the actual degree of processing to the crop material achieved by the crop processor 40A, 40B. The step of adjusting the crop processor 40A, 40B is generally indicated by box 222 in FIG. 6. For example, if the actual degree of kernel fracture is less than the pre-defined allowable characteristic range, then the computing device 86 may automatically reduce the roll gap 52 between the first processing roll 48 and/or the second processing roll 50. Alternatively, if the actual cut length of the crop material is less than the pre-defined allowable characteristic range, then the computing device 86 may change the relative position between the shear bar 46 and the rotating cylindrical drum 42 to change the actual cut length.

As noted above, the computing device 86 may include the GPS system 102 that is capable of receiving location data and determining a geographic location of the harvester implement 20. As such, the processor 88 may be operable to execute the crop processing analysis algorithm 104 to determine a geographic location of the crop material captured in the post-processing image 68, using the GPS system 102. The step of determining the geographic location is generally indicated by box 224 in FIG. 6. The computing device 86 may associate the geographic location with the post-processing image 68, and include the geographic location in the notification signal communicated to the output 62.

The processor 88 may further be operable to execute the crop processing analysis algorithm 104 to communicate the post-processing image 68, the actual degree of processing to the crop material, and the geographic location associated with the post-processing image 68, as well as other data if desired, to a remote data storage and/or access location 116. The step of communicating data to the access location 116 is generally indicated by box 226 in FIG. 6. The remote data storage and/or access location 116 may include a Cloud based network 118, a third party off-site data storage system, or the like. The data communicated to the remote data storage and/or access location 116 may be accessed by personnel remotely located from the harvester implement 20, such as remote operators, remote managers, trusted partners, nutritionists, etc. Additionally, the data communicated to the remote data storage and/or access location 116 may optionally be accessed by third party partners of the user.

Remote access to the real time data obtained from the post-processing image 68 may enable real time adjustments and/or decisions from users located remote from the harvester implement 20. For example, the processor 88 may be operable to execute the crop processing analysis algorithm 104 to receive a setting control input signal 122 from a remote transmitter 120. The step of receiving the setting control input signal 122 is generally indicated by box 228 in FIG. 6. The setting control input signal 122 may include recommended changes to the settings of the crop processor 40A, 40B, changes to the desired level of processing, etc. The computing device 86 may prompt the user to apply the proposed changes included in the setting control signal, or automatically adjust the crop processor 40A, 40B to change the actual degree of processing of the crop material based on the setting control signal. As such, the computing device 86 may automatically present a message on the output 62 requesting a change to the crop processor 40A, 40B, based on the setting control input signal 122. In another implementation, the computing device 86 may automatically change the settings of the crop processor 40A, 40B, e.g., the cut length or the roll gap 52, based on the setting control input signal 122.

As noted above, the harvester implement 20 may include the NIR sensor 82 that is capable of sensing the NIR image of the crop material. The processor 88 may be operable to execute the crop processing analysis algorithm 104 to analyze the NIR image to determine a moisture content and/or a starch content of the crop material. The moisture content and/or starch content of the crop material may be included in the notification signal communicated to the output 62, or may be included in the data communicated to the remote location 116.

It may be desirable to improve or increase digestible starch in the diet of some animals. For example, milk production in cows is dependent upon available or digestible starch. Starch is a major energy source for lactating dairy cows when digested in the rumen and/or absorbed in the intestine as glucose. Increasing ruminal starch digestion improves microbial protein synthesis, which is the main amino acid source for absorption in the small intestine. Improving or increasing the available or digestible starch in the cow's diet may increase milk production. If corn is too mature, however, the starch may be difficult for a cow to digest. Starch content in corn, for example, may range between 18% and 48%. However, the starch content in corn that is available or digestible by a cow may range between 5.8% and 7.8%.

As used herein, “e.g.” is utilized to non-exhaustively list examples, and carries the same meaning as alternative illustrative phrases such as “including,” “including, but not limited to,” and “including without limitation.” As used herein, unless otherwise limited or modified, lists with elements that are separated by conjunctive terms (e.g., “and”) and that are also preceded by the phrase “one or more of,” “at least one of,” “at least,” or a like phrase, indicate configurations or arrangements that potentially include individual elements of the list, or any combination thereof. For example, “at least one of A, B, and C” and “one or more of A, B, and C” each indicate the possibility of only A, only B, only C, or any combination of two or more of A, B, and C (A and B; A and C; B and C; or A, B, and C). As used herein, the singular forms “a”, “an” and “the” are intended to include the plural forms as well, unless the context clearly indicates otherwise. Further, “comprises,” “includes,” and like phrases are intended to specify the presence of stated features, steps, operations, elements, and/or components, but do not preclude the presence or addition of one or more other features, steps, operations, elements, components, and/or groups thereof.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

1. A harvester implement comprising:
a head unit operable to gather crop material and direct the crop material along a flow path;
a crop processor positioned to receive the crop material from the head unit and partially define the flow path of the crop material, wherein the crop processor is operable to process the crop material to alter a characteristic of the crop material;
an image sensor assembly positioned downstream of the crop processor along the flow path of the crop material, and operable to capture a post-processing image of the crop material as the crop material moves along the flow path;
a computing device in communication with the image sensor assembly and including a processor and a memory having a crop processing analysis algorithm stored thereon, wherein the processor is operable to execute the crop processing analysis algorithm to:
receive the post-processing image of the crop material from the image sensor assembly;
analyze the post-processing image to determine an actual degree of processing to the characteristic of the crop material achieved by the crop processor; and
communicate a notification signal to an output indicating the actual degree of processing to the characteristic of the crop material.

2. The harvester implement set forth in claim 1, further comprising a discharge spout positioned to receive the crop material from the crop processor and partially define the flow path of the crop material.

3. The harvester implement set forth in claim 2, wherein the image sensor assembly is positioned in the discharge spout.

4. The harvester implement set forth in claim 1, wherein the characteristic of the crop material includes a cut length, and wherein the crop processor includes a cutter head operable to cut the crop material to alter the cut length of the crop material.

5. The harvester implement set forth in claim 4, wherein the processor of the computing device is operable to execute the crop processing analysis algorithm to analyze the post-processing image to determine an actual cut length of the crop material achieved by the cutter head.

6. The harvester implement set forth in claim 1, wherein the characteristic of the crop material includes a kernel wall, and wherein the crop processor includes a kernel processor operable to fracture the kernel wall.

7. The harvester implement set forth in claim 6, wherein the processor of the computing device is operable to execute the crop processing analysis algorithm to analyze the post-processing image to determine an actual degree of kernel fracture.

8. The harvester implement set forth in claim 7, wherein the processor of the computing device is operable to execute the crop processing analysis algorithm to relate the actual degree of kernel fracture to a kernel processing score.

9. The harvester implement set forth in claim 1, wherein the image sensor assembly includes a window covering exposed to the crop material moving along the flow path.

10. The harvester implement set forth in claim 9, wherein the window covering is sapphire glass or ceramic glass.

11. The harvester implement set forth in claim 9, wherein the image sensor assembly includes a housing defining an interior region and supporting at least one light source within the interior region.

12. The harvester implement set forth in claim 11, wherein the at least one light source is positioned to provide direct lighting through the window covering and onto the crop material in the flow path.

13. The harvester implement set forth in claim 11, wherein the at least one light source includes a pulsed Light Emitting Diode (LED).

14. The harvester implement set forth in claim 1, wherein the image sensor assembly includes a camera module having a shutter speed equal to or less than twenty milliseconds.

15. The harvester implement set forth in claim 14, wherein the camera module is operable to capture the post-processing image in a visible light spectrum.

16. The harvester implement set forth in claim 15, wherein the visible light spectrum includes light having a wavelength between the range of approximately 380 nanometers and 700 nanometers.

17. The harvester implement set forth in claim 1, further comprising a Near InfraRed (NIR) sensor positioned to capture a NIR image of the crop material in a NIR light spectrum.

18. The harvester implement set forth in claim 17, wherein the processor is operable to execute the crop processing analysis algorithm to analyze the NIR image to determine a starch content.

19. The harvester implement set forth in claim 18, wherein the processor is operable to execute the crop processing analysis algorithm to communicate the notification signal to the output indicating the starch content.

20. The harvester implement set forth in claim 1, wherein the output includes a visual display.

21. The harvester implement set forth in claim 20, wherein the processor is operable to execute the crop processing analysis algorithm to communicate the notification signal to present the post-processing image on the visual display.

22. The harvester implement set forth in claim 21, wherein the processor is operable to execute the crop processing analysis algorithm to communicate the notification signal to the output indicating an actual cut length of the crop material.

23. The harvester implement set forth in claim 21, wherein the processor is operable to execute the crop processing analysis algorithm to communicate the notification signal to the output indicating an actual degree of kernel processing.

24. The harvester implement set forth in claim 21, wherein the processor is operable to execute the crop processing analysis algorithm to communicate the notification signal to the output indicating a kernel processing score.

25. The harvester implement set forth in claim 1, wherein the processor is operable to execute the crop processing analysis algorithm to compare the actual degree of processing to a pre-defined allowable characteristic range to determine if the actual degree of processing is equal to or within the pre-defined allowable characteristic range or if the actual degree of processing is outside the allowable characteristic range.

26. The harvester implement set forth in claim 25, wherein the processor is operable to execute the crop processing analysis algorithm to communicate the notification signal indicating that the actual degree of processing is equal to or within the pre-defined allowable characteristic range or that the actual degree of processing is outside the allowable characteristic range.

27. The harvester implement set forth in claim 1, wherein the processor is operable to execute the crop processing analysis algorithm to identify a potential maintenance requirement associated with the crop processor based on the actual degree of processing to the crop material achieved by the crop processor.

28. The harvester implement set forth in claim 1, wherein the processor is operable to execute the crop processing analysis algorithm to automatically adjust the crop processor to change the actual degree of processing to the crop material achieved by the crop processor.

29. The harvester implement set forth in claim 1, wherein the processor is operable to execute the crop processing analysis algorithm to determine a geographic location of the crop material captured in the post-processing image.

30. The harvester implement set forth in claim 29, wherein the processor is operable to execute the crop processing analysis algorithm to associate the geographic location with the post-processing image.

31. The harvester implement set forth in claim 30, wherein the processor is operable to execute the crop processing analysis algorithm to communicate the post-processing image, the actual degree of processing to the crop material, and the geographic location associated with the post-processing image, to a remote data storage location.

32. The harvester implement set forth in claim 31, wherein the processor is operable to execute the crop processing analysis algorithm to receive a setting control input signal from a remote transmitter.

33. The harvester implement set forth in claim 32, wherein the processor is operable to execute the crop processing analysis algorithm to adjust the crop processor to change the actual degree of processing of the crop material based on the setting control signal.

34. The harvester implement set forth in claim 2, further compromising a storage container positioned to receive the crop material from the discharge spout, and wherein the image sensor assembly is positioned to capture the post-processing image of the crop material in the storage container.

35. The harvester implement set forth in claim 2, wherein the image sensor assembly is positioned to capture the post-processing image upstream of the discharge spout relative to the flow path of the crop material.
